(19) United States
(12) Patent Application Publication
(10) Pub. No.: US 2025/0102089 A1
(43) Pub. Date: Mar. 27, 2025

(54) SENSOR QUICK-CONNECTION SYSTEM AND METHOD

(71) Applicant: Mueller International, LLC, Atlanta, GA (US)

(72) Inventors: Mohammad Hassan Sobhani, Toronto (CA); Daryl Lee Gibson, Chattanooga, TN (US)

(21) Appl. No.: 18/373,736

(22) Filed: Sep. 27, 2023

(51) Int. Cl. F16L 37/092

(52) U.S. Cl. CPC F16L 37/0925

(57) ABSTRACT

A quick connect sensor coupling is described. The sensor coupling comprises a housing defining a first portion and a second portion; a sensor captured within the first portion; and a gripper stop comprising a taped surface and captured between the second portion and a pipe.

### TECHNICAL FIELD

This disclosure relates to sensors in a utility system. More specifically, this disclosure relates to the rapid, repeatable, and secure coupling of a sensor, such as a hydrophone, into a utility system, such as a water utility.

### BACKGROUND

A municipal utility system (e.g., a water system) can include various complex components designed to collect, treat, and distribute water to residences, businesses, and/or other facilities, e.g., within a city or town. The water, or other utility, typically must be sourced, cleaned, and distributed to each facility, usually through piping components. The quality and quantity of the source water can significantly impact the operation of the municipal water system, and regular inspections and maintenance of the system can ensure that the structure is safe and efficiently providing residents with potable drinking water. Since each component of the utility system plays a crucial role in delivering safe, reliable water supplies, the system should be carefully managed and maintained to protect public health, support economic activity, and/or safeguard the environment.

Sensors can be attached to the system. Methods of attachment and/or detachment of such sensors can damage the sensor and/or interfere with the utility services.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a sensor coupling comprising: a housing defining a first portion and a second portion, a sensor captured within the first portion, and a gripper stop comprising a taped surface and captured between the second portion and a pipe.

In a further aspect, disclosed is a quick-connect sensor coupling comprising: a housing defining a first portion and a second portion defining an angled section, a hydrophone coupled to an electronic transmitting device and disposed within a cavity defined within the first portion, and a gripper stop comprising a tapered surface and captured between the angled section of the second portion.

In yet another aspect, disclosed is a sensor coupling comprising: a housing defining a first portion and a second portion defining an angled section, a sensor coupled to an electronic transmitting device and disposed within a cavity defined within the first portion, and a gripper stop comprising a tapered surface and captured between the angled section of the second portion and a pipe.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and, together with the description, serve to explain various principles of the disclosure. The drawings are not necessarily drawn to scale. Corresponding features and components throughout the figures may be designated by matching reference characters for the sake of consistency and clarity.

FIG. 1 is a perspective view of a sensor coupling assembly coupled to a pipe in accordance with one aspect of the current disclosure.

FIG. 2 is an exploded view of the sensor coupling assembly coupled to the pipe, shown in FIG. 1.

FIG. 3 is a cross-sectional view of the sensor coupling assembly shown in FIG. 1 taken along line 3-3 of FIG. 1.

FIG. 4 is a perspective view of a sensor coupling assembly coupled to a pipe in accordance with another aspect of the current disclosure.

FIG. 5 is an exploded view of the sensor coupling assembly coupled to the pipe, shown in FIG. 4

FIG. 6 is a cross-sectional view of the sensor coupling assembly shown in FIG. 1, taken along line 6-6 of FIG. 4.

### DETAILED DESCRIPTION

The present disclosure can be understood more readily by reference to the following detailed description, examples, drawings, and claims, and their previous and following description. However, before the present devices, systems, and/or methods are disclosed and described, it is understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

In one aspect, a quick-connect system for attaching a sensor and associated methods, systems, devices, and various apparatuses are disclosed herein. In one aspect, the quick-connect system can comprise a housing that orients the sensor in a fluid column and securely and quickly attaches the sensor without the need to rotate the sensor or housing.

One method of managing and inspecting a utility system involves a sensor, such as a microphone adapted to function in a liquid environment or a hydrophone. A sensor, such as a hydrophone, is a type of microphone specifically designed to be used underwater to record and/or listen to underwater sounds. Most sensors of this type, including hydrophones, utilize a piezoelectric transducer that generates an electric potential when subjected to a pressure change, such as an underwater sound wave. The sensor can detect leaks by listening to the escaping water or gas-generated sounds. In some examples, hydrophones can pinpoint the leak location along a pipeline, which can be especially useful for large-scale infrastructure like water mains or oil and gas pipelines, where leaks can lead to significant economic and environmental damage.

Sensors such as hydrophones can also be used to monitor the pipeline integrity. For example, sounds made by a pipeline can give clues to its overall health. Changes in the usual noise level can indicate a problem with the pipeline's operation, a blockage, and/or an improperly functioning valve. In some cases, hydrophones and other sensors can monitor pipelines for signs of tampering and/or unauthorized activity. For example, the hydrophone system could detect the sound of drilling or other mechanical work. Fluid sensors and hydrophones can benefit testing of plumbing systems or technologies, for example, to study the effects of different flow rates or pressures on the noise produced by a system.

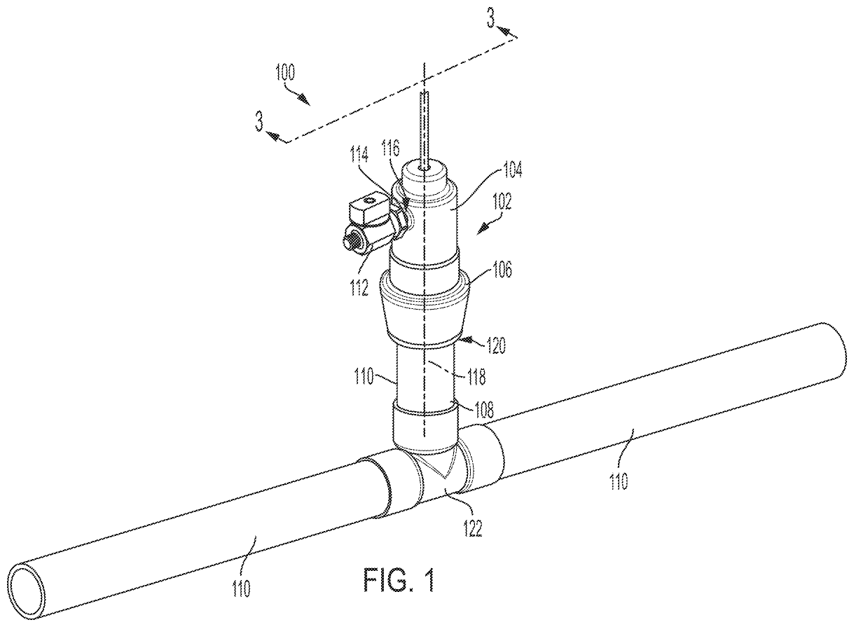

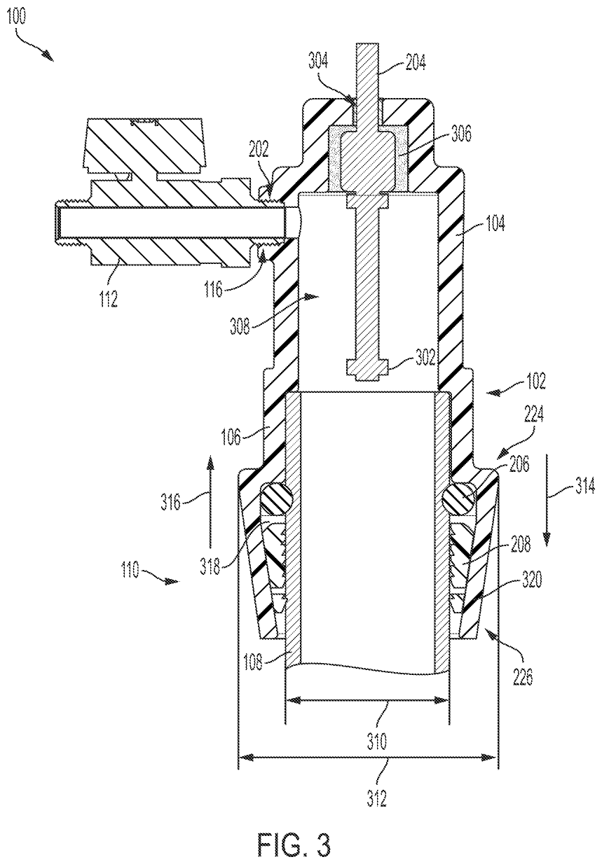

One aspect of a quick-connect sensor coupling or sensor coupling assembly 100 is disclosed and described in FIG. 1. The sensor coupling assembly 100 comprises a housing 102 comprising an upper or sensor portion 104 and a lower or gripping portion 106. In various aspects, housing 102 can comprise any material. For example, housing 102 can comprise a material that is NSF 61 approved, or in other aspects can comprise any material as desired. For example, housing 102 can comprise steel, such as stainless steel, and brass, such as low lead brass. Sensor portion 104 houses and protects the sensing equipment (e.g., a hydrophone or other sensor 302, as illustrated in FIG. 3). Gripping portion 106 securely couples and/or fastens housing 102 to an end of a branch 108, e.g., a pipe 110 extending upward from a fitting 122. The fitting 122 can connect two pipes 110 that are configured for transferring water through the utility, shown in FIG. 1 extending laterally from fitting 122. A third pipe 110 can comprise the branch 108, shown extending upward from the fitting 122 in FIG. 1, where the sensor 302 (e.g., a hydrophone) can attach. The branch 108 can be housed within a pit, which provides an underground cylindrical (or other shaped) housing for the hydrophone. In some aspects, the fitting 122 can also be located within the pit, and the laterally extending pipes 110 can extend out through sides of the pit. In other aspects, the fitting 122 can be below the pit and the branch 108 can extend upward from the fitting 122 into the pit. Various branches 108, pipes 110, fittings 122 and/or pits can be located in designated spots along the piping infrastructure to install monitoring hydrophones or other equipment along pipe 110. For example, a T-fitting (e.g., fitting 122) can be installed along the axis of pipe 110 to install a transverse branch 108 that can be coupled to housing 102 of a sensor coupling assembly 100. In various aspects, fitting 122 can comprise another suitable fitting, such as and without limitation, a Y-fitting, an L-fitting, an X-fitting, a saddle fitting, or another suitable fitting for jointing branch 108 to pipes 110.

In some aspects, an air release valve 112 can be secured to housing 102. In various aspects, the air release valve 112 can be a ball valve, butterfly valve, or any other suitable valve. For example, the air release valve 112 can be threadedly coupled into a threaded portion 114 of housing 102 to secure the air release valve 112. A threaded hole 116 in housing 102 comprises the threaded portion and couples to the air release valve 112. When air release valve 112 is coupled to the threaded hole 116, the air release valve extends radially from housing 102. In some aspects, threaded hole 116 comprises threaded portion 114 to orient the air release valve 112. In the illustrated aspect, the threaded hole 116 orients the air release valve 112 in a direction that is perpendicular to a central axis 118 of housing 102 such that the air release valve 112 extends radially outward from housing 102. As illustrated, the hydrophone (or other sensors 302 of FIG. 3) is coupled to one end of housing 102, and a pipe end 120 of sensor 302 (FIG. 3) couples to branch 108 of pipe 110 at the opposite axial end of housing 102, extending along the central axis 118.

Air release valve 112 facilitates bleeding pipe 110 following installation of the sensor coupling assembly 100, e.g., under pressure. For example, when a hydrophone or other sensor coupling assembly 100 is added to branch 108, the pipe 110 can be charged and/or pressurized. The installation process may not ‘shut off’ the line and can proceed while the water line is pressurized. When the sensor coupling assembly 100 is coupled to pipe 110, any air trapped inside branch 108 can be bled out of branch 108 and/or pipe 110 to enhance the reliability of the sensing equipment and reduce the maintenance and wear and tear on the sensing equipment. Air in the system can act as a dampener and reduce the magnitude of the noise carried in the water. Thus, the air is a dampener that can reduce the strength of the signal at the hydrophone or other transducer. Air release valve 112 facilitates the bleeding off of any trapped air in branch 108 and/or pipe 110 and enhances the functionality of the sensor coupling assembly 100.

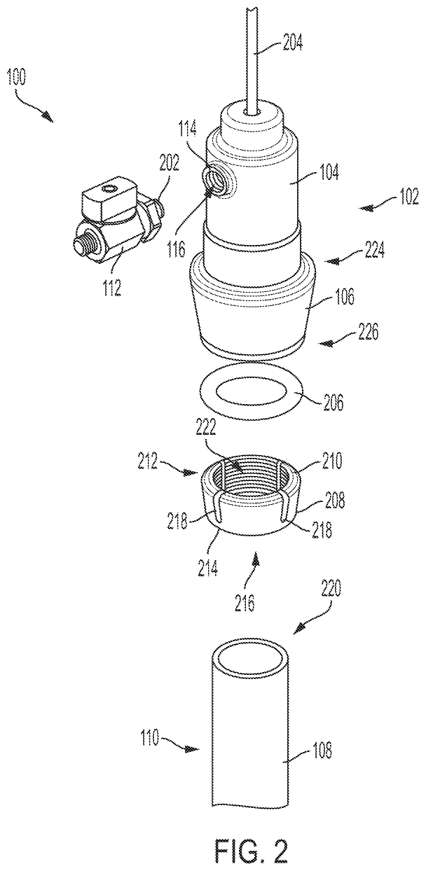

FIG. 2 shows an exploded view of the sensor coupling assembly 100 to illustrate the different features of the components described above in relation to FIG. 1. Specifically, the threaded portion 114 of housing 102 is visible, as well as male threads 202 located on the air release valve 112 configured to threadedly secure the air release valve 112 into housing 102. In various aspects, the sensing equipment is a transducer, such as a hydrophone, and without limitation, can comprise a pressure transducer, an electric transducer, and/or a vibratory transducer. The transducer (e.g., sensor 302, illustrated in FIG. 3) can have a relay structure, shown as an electric cable 204, configured to relay information about the transducer to a computer or pressure monitoring system. Cable 204 can comprise one or more wires (e.g., multiple wires) and can provide power to the transducer and/or relay information about changes within the transducer, e.g., electronically to an electronically coupled computer structure or network.

An O-ring seal or seal 206 can be disposed within the coupling or gripping portion 106 of housing 102. Seal 206 can be manufactured from an elastomer (e.g., rubber and/or moldable plastic) and can be captured between housing 102 and pipe 110. In some aspects, a gap may exist between the gripping portion 106 and seal 206. A gripping stop 208 can comprise a chamfer 210 on one end 212 and a circumferential lip 214 on an opposite end 216. Various slots 218 can extend axially relative to pipe 110 through the gripping stop 208 and facilitate a sliding movement of the sensor coupling assembly 100 onto a pipe-end 220 of pipe 110 by allowing flexure of the portions of the gripping stop adjacent to slots 218. Gripping stop 208 can also comprise compressible teeth 222 configured to securely grip into branch 108, pipe 110, and/or pipe end 220 and prevent housing 102 of sensor coupling assembly 100 from detaching from the designated branch 108 installed to monitor the pipe 110. The slots 218 allow flexure that enables the teeth 222 to grip the branch 108, pipe 110, and/or pipe end 220. Gripping stop 208 can be molded or manufactured from plastic (e.g., HDPE) and/or metal, such as various non-corrosive steels and/or brass, or another high-strength material that is capable of securely gripping an outer wall of branch 108 and/or pipe 110 with the teeth 222 of gripping stop 208. In various aspects, the gripping stop 208 can securely grip the branch 108 and/or pipe 110 without penetrating and weakening the branch 108 and/or pipe 110.

Gripping stop 208 and seal 206 are housed within the gripping portion 106 of housing 102 and captured between an upper or broader portion 224 and a lower or narrower portion 226 of the gripping portion 106 of housing 102. In this way, both gripping stop 208 and seal 206 are captured within the gripping portion 106 of housing 102, and as housing 102 (e.g., comprising sensor 302 shown in FIG. 3) slides over pipe end 220 and onto branch 108 and/or pipe 110, sensor 302 can slide within the branch 108 to measure and/or monitor the utility system. Any excess air trapped within housing 102 can be bled off. For example, if sensor 302 is a hydrophone and pipe 110 is carrying water, the hydrophone can be completely submerged in the water at the designated branch 108 of pipe 110 and can accurately monitor the system and detect changes in the sounds generated by the system to detect blockages, faulty valves, and/or potential leaks.

In some aspects, gripping stop 208 is a tapered piece, comprising a chamfer 210 and slots 218. Slots 218 facilitate compressing the gripping stop 208 in order to facilitate placement of housing 102 over the gripping stop. The housing 102 and the gripping stop can be assembled by hand. Chamfer 210 can facilitate slipping housing 102 over the compressed gripping stop 208. For example, housing 102 can be installed over gripping stop 208 by aligning and pushing housing 102 over the chamfer 210 to place housing 102 over the gripping stop 208. Once housing 102 is installed over the gripping stop 208, housing 102 can be pushed, then pulled, to secure the teeth 222 of gripping stop 208 against the outer wall of branch 108 and/or pipe 110. For example, gripper stop 208 can comprise slots 218 extending axially parallel to the central axis that extends at least partially through the gripper stop 208. Similarly, gripper stop 208 can comprise a chamfer 210 to facilitate translating the gripper stop 208 over housing 102 and/or within housing 102.

In various aspects, this configuration enables the attachment of a sensor coupling assembly 100 comprising a sensor without rotation of housing 102. Housing 102 can be slid onto pipe end 220 and fixed. In the aspect shown in FIG. 2, the attachment can be semi-permanent. As used herein, a semi-permanent attachment is not permanent in the sense that it cannot possibly be removed, but the removal of a semi-permanent attachment is difficult without breaking the pipe and/or one or more portions or components of the sensor coupling assembly 100. Therefore, in this aspect, once sensor coupling assembly 100 is attached to branch 108 at pipe end 220 in a semi-permanent fashion, it remains affixed until branch 108, pipe 110, and/or housing 102 is effectively removed entirely and replaced.

FIG. 3 shows a cross-section of the sensor coupling assembly 100 taken along line 3-3 of FIG. 1. The illustrated portions are shown in a simplified format. For example, the air release valve 112 and/or sensor 302 may not be solid pieces of material as illustrated and can have additional components which have not been illustrated. The cable 204 can be coupled to sensor 302 and can exchange information over a network. For example, sensor 302 (e.g., a hydrophone) can be coupled to an electronic transmitting device, such as cable 204 or a wireless network, to transmit electronic signals. Cable 204 securely passes through an orifice 304 of housing 102 to secure sensor 302, e.g., in a water column in branch 108 that can be separated from the water flow through a central pipe 110 with a T-fitting (e.g., fitting 122) to secure sensor 302 within branch 108. In various aspects, potting or a gasket can be used to form a seal and secure sensor 302 within branch 108. Sensor 302 and/or cable 204 can be securely fastened within sensor portion 104 of housing 102 with a sealing compound 306, e.g., a potting compound or other molding that seals the sensor 302 and housing 102 interface. As shown, sensor 302 extends into a housing cavity 308 that can be within the water column, but sensor 302 does not extend all the way into branch 108 of pipe 110. In this way, sensor 302 can be protected from the flow, debris, or other obstructions within pipe 110 to protect the sensor 302. In various aspects, sensor 302 can be a hydrophone, a water quality sensor, a pressure sensor, a velocity sensor, etc. The sensor coupling assembly 100 comprises a housing 102 configured to quickly connect the sensor 302 to the water column in a branch 108 of the pipe 110. The connection of sensor 302 in branch 108 can be reliable and secure enough that sensor 302 can provide accurate and repeatable data collection, e.g., following a calibration process.

In various aspects, a diameter 310 of transverse pipe 110 to form branch 108 can be less than 1 inch, such that a maximum diameter 312 of housing 102 at the gripping portion 106 can be less than 1.5 inches. More specifically, the maximum diameter of housing 102 at the gripping portion 106 can be, for example, and without limitation, less than 1.25 inches, 1 inch, 0.75 inches, or 0.5 inches, such that installation of housing 102 in narrow locations is feasible, even without a screwing or other transverse or rotational motion of the sensor coupling assembly 100.

The narrow profile of housing 102 means that the sensor coupling assembly 100 can be affixed to a broader variety of branches 108 and/or pipes 110 and can enhance the overall system reliability to detect and locate leaks or other problems within the piping system. In some aspects, the maximum diameter 312 of housing 102 at the gripping portion 106 can be, for example, and without limitation, less than 25%, 20%, 15%, 10%, or 5% greater than the diameter 310 of the branch 108. In various aspects, the maximum outer diameter 312 (e.g., of a portion of housing 102) is less than, for example, and without limitation, 25% greater than an outer diameter of pipe 110. Since the sensor coupling assembly 100 slides axially over the transverse pipe 110 to form branch 108, the narrow cross-section at the maximum diameter 312 facilitates the secure attachment of sensors 302 where they may have been impossible with a more conventional, e.g., threaded assembly.

As illustrated in FIG. 3, when housing 102 is pressed in a downward direction 314, gripping stop 208 can slide in an upward direction 316 (e.g., opposite the downward direction 314) into a pocket 318 of the gripping portion 106 of housing 102. When gripping stop 208 compresses the seal 206, the pocket 318 is reduced, and the seal 206 can be compressed to form a fluid-tight sealing boundary around pipe end 220. If housing 102 is pulled in the upward direction 316, e.g., to remove housing 102 from the pipe end 220, angled sections 320 of the gripping portion 106 compress the gripping stop 208. The taper on the gripping stop 208 interacts with the angled sections 320 to prevent removing housing 102 from the pipe end 220. The greater the force in the upward direction 316, the greater the gripping stop 208 secures housing 102 to the pipe end 220 by pushing the teeth 222 to further increase contact pressure on pipe 110 to create a secure connection for sensor 302 within the water column of branch 108.

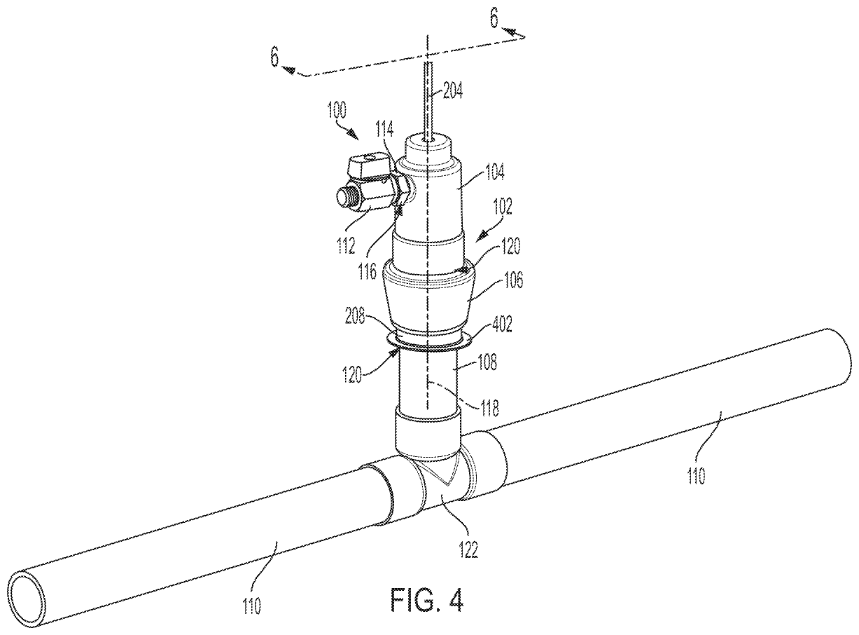

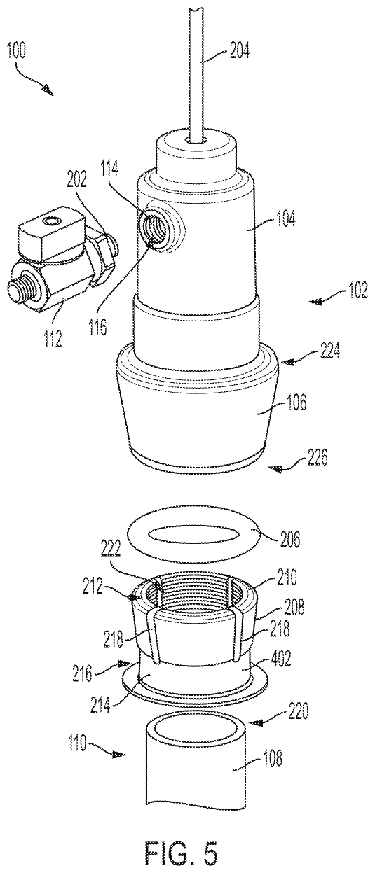

FIGS. 4-6 show another aspect of a sensor coupling assembly 100. The sensor coupling assembly 100 shown in FIG. 4 is the same as illustrated in FIGS. 1-3, except the sensor coupling assembly 100 in FIG. 4 further comprises a gripper flange 402 inserted within the angled sections 320 of the gripping portion 106. Accordingly, all the description of FIGS. 1-3 applies equally to the description of FIGS. 4-6, and FIGS. 4-6 further comprise structures and features that enable the removal and replacement of the sensor coupling assembly 100. FIGS. 1-3 describe an assembly that has a semi-permanent attachment and cannot be easily removed without replacing branch 108, pipe 110, and/or sensor 302. FIGS. 4-6 describe a removable attachment where the sensor coupling assembly 100 can be removed and replaced from one branch 108 to another without replacement of the branch 108, pipe 110, or sensor 302.

Concerning FIGS. 4-6, the sensor coupling assembly 100 comprises housing 102, defining upper/sensor portion 104 and lower/gripping portion 106. Housing 102 can be manufactured from any suitable material, including NSF 61 approved materials. In aspects, housing 102 can comprise steel (e.g., stainless steel) and/or brass (e.g., low lead brass). Sensor portion 104 houses and protects the sensing equipment, e.g., sensor 302, FIG. 3. Gripping portion 106 securely couples and/or fastens housing 102 to an end of a pipe 110, e.g., a water branch 108 off of pipe 110 configured for transferring water through the utility. The transverse pipe 110 can be formed using a T-fitting (e.g., fitting 122) to create a monitoring junction or branch 108. Branches 108 and/or pipes 110 can be located in designated spots along the piping infrastructure to install sensor-monitoring equipment. Air release valve 112 can be secured to housing 102 to facilitate bleeding the branch 108 and/or pipe 110 following a hot installation of the sensor coupling assembly 100. Air release valve 112 facilitates the bleeding off of any trapped air in branch 108 and/or pipe 110 and enhances the functionality of the sensor coupling assembly 100. In other aspects, housing 102 can define a minimum diameter 312 at sensor portion 104 and a maximum diameter 312 at gripping portion 106. In various aspects, the maximum diameter 312 at the gripping portion 106 can be, for example and without limitation, less than 25%, 20%, 15%, 10%, or 5% greater than the minimum diameter 312 of the sensor portion 104.

Sensor 302 can be located in a column of fluid, e.g., water, and inside a branch 108 defined by housing 102 outside the system's axial flow. Air and other impurities are released through the air release valve 112 so that sensor 302 can more accurately monitor the system. Seal 206 can be captured within angled sections 320 of housing 102 at the gripping portion 106, and the tapered surfaces of gripping stop 208 interact with angled sections 320 to lock housing 102 (and the sensor coupling assembly 100) onto the pipe end 220 of branch 108 and/or pipe 110 with an axial motion. Gripper flange 402 can be captured at the end of angled sections 320 and facilitates removal of housing 102 and sensor coupling assembly 100. For example, by sliding the gripper flange in the upward direction, the angled sections are disengaged from the tapered surface of the gripper stop 208, and the stopper assembly, 100 and/or housing 102, can be removed and/or replaced from pipe end 220 without replacing branch 108 and/or pipe 110. In various aspects, the sensor coupling assembly 100 can be removed and replaced or removed and repaired, such that the gripper flange 402 facilitates the removal and interchange of sensor coupling assemblies 100 at each branch 108 and/or pipe 110.

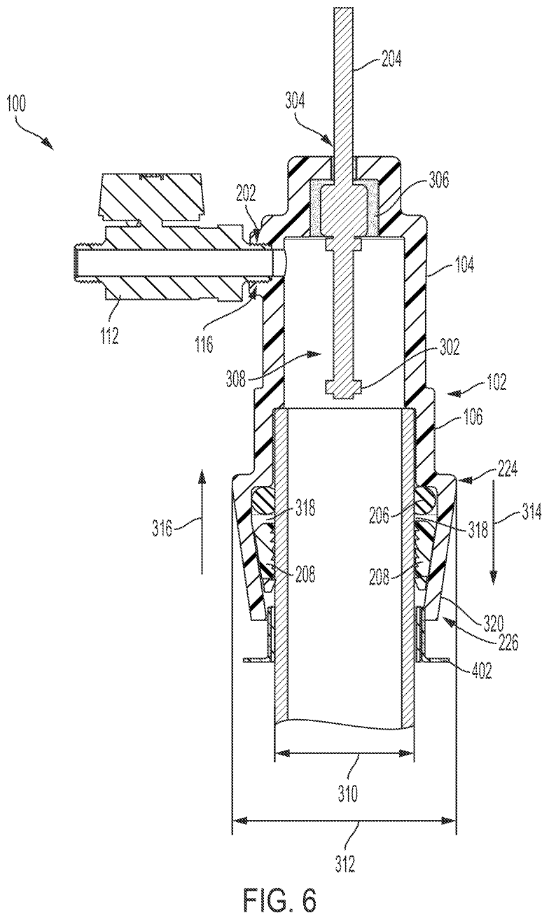

With reference to FIGS. 3-6, in various aspects, gripper flange 402 can be a unitary component of gripper stop 208. Gripper flange 402 is illustrated in FIGS. 4-6 and can comprise a flange portion 404 and an insertion portion 406. Flange portion 404 surrounds and extends radially from the insertion portion 406, and both flange portion 404 and insertion portion can be defined by a flat profile (e.g., as shown in FIG. 6) rotated around central axis 118. Stated differently, both flange portion 404 and insertion portion 406 are arcuate or ring-shaped and have an “L-shaped” cross-sectional profile. As specifically illustrated in FIG. 4, the flange portion 404 facilitates the operator to insert and/or release the insertion portion 406 of the gripper flange 402. Insertion portion 406 securely couples sensor 302, but the flange portion 404 can be used to remove and release the gripper flange 402 to remove sensor 302 from branch 108.

Both gripper flange 402 and gripper stop 208 can form a single unitary part. For example, one or more of the gripper flange 402 and/or the gripper stop 208 can be a single monolithic part or piece. In this configuration, an operator could reach down on housing 102 to find the gripper flange 402 and, by pulling up on the gripper flange 402 in direction 316, release the gripper stop 208 from branch 108 (e.g., pipe 110) and remove housing 102 from pipe end 220. In other aspects, gripper flange 402 can be a separate part or another component adjacent to gripper stop 208 and captured or trapped between angled sections 320 of housing 102 and pipe 110. In this configuration, the operator would follow the same process to remove the sensor coupling assembly 100 from pipe end 220 but can bring a suitable gripper flange 402 (e.g., based on the dimensions or diameter of pipe 110). When sensor coupling assembly 100 is coupled to pipe end 220, housing 102 can comprise a pocket 318 filled as gripper stop 208 moves in an upward direction 316 relative to the downward direction 314 of housing 102 relative to pipe 110 to attach the sensor coupling assembly 100 at branch 108 securely.

With reference to FIGS. 1-6, in some aspects, a method for installing the sensor coupling 100 comprises sliding housing 102 (comprising gripper stop 208 and sensor 302) over pipe 110. The gripper stop 208 can comprise a tapered surface and/or teeth 222 captured between housing 102 and pipe 110 to secure housing 102 to pipe 110. For example, the housing 102 is secured to the branch 108 of pipe 110 by exerting an upward force, e.g., a force on the housing 102 in a direction opposite or away from the branch 108 of pipe 110. The force on the housing 102 in a direction opposite from the branch 108 of pipe 110 compresses the tapered surface comprising teeth 222 and drives teeth 222 into the outer surface of branch 108 of pipe 110 to secure housing 102 on branch 108 of pipe 110. In some aspects, the method can comprise releasing housing 102 from the branch 108 of pipe 110 by exerting another force on the gripper stop 208. The force to release housing 102 is applied in the same direction, e.g., in a direction opposite from the branch 108 of pipe 110, but the force is exerted on the gripper stop 208 rather than housing 102.

The description is an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an,” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint and independently of the other endpoint.

For the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur and that the description comprises instances where said event or circumstance occurs and instances where it does not.

The word “or” as used herein means any one member of a particular list and also comprises any combination of members of that list. The phrase “at least one of A and B,” as used herein, means “only A, only B, or both A and B”; while the phrase “one of A and B” means “A or B.”

As used herein, unless the context clearly dictates otherwise, the term “monolithic” in the description of a component means that the component is formed as a singular component that constitutes a single material without joints or seams.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of the seat nearest to and occupied by a user of a seat; “rear” is that end of the seat that is opposite or distal to the front; “left” is that which is to the left of or facing left from a person sitting in the seat and facing towards the front; and “right” is that which is to the right of or facing right from that same person while sitting in the seat and facing towards the front. “Horizontal” or “horizontal orientation” describes that which is in a plane extending from left to right and aligned with the horizon. “Vertical” or “vertical orientation” describes that which is in a plane angled at 90 degrees to the horizontal.

One should note that conditional language, such as, among others, “can,” “could,” “might,” or “may,” unless specifically stated otherwise or otherwise understood within the context as used, is generally intended to convey that certain aspects include, while other aspects do not include, certain features, elements and/or steps. Thus, such conditional language is not generally intended to imply that features, elements, and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A sensor coupling comprising:
a housing defining a first portion and a second portion;
a sensor captured within the first portion; and
a gripper stop comprising a tapered surface and captured between the second portion and a pipe.

2. The sensor coupling of claim 1, wherein a maximum outer diameter of the second portion is less than an outer diameter of the pipe.

3. The sensor coupling of claim 1, wherein the sensor is selected from the group consisting of a hydrophone, a pressure sensor, a water quality sensor, and a velocity sensor.

4. The sensor coupling of claim 1, further comprising a potting compound securing a cable coupled to the sensor and securing the sensor within a water column of the housing.

5. The sensor coupling of claim 1, further comprising an air release valve coupled proximate to a top of the first portion of the housing, wherein the air release valve is configured to remove air from within a water column following installation.

6. The sensor coupling of claim 1, wherein an air release valve is threadedly coupled to the housing.

7. The sensor coupling of claim 1, wherein the second portion comprises angled sections that are opposed to the tapered surface of the gripper stop, wherein as the gripper stop moves relative to the angled sections, a compressive force of the gripper stop is increased.

8. The sensor coupling of claim 1, wherein the gripper stop comprises a slot extending axially parallel to a central axis and at least partially through the gripper stop to facilitate translating the gripper stop within the housing.

9. The sensor coupling of claim 1, wherein the gripper stop comprises a chamfer configured to receive an O-ring seal within a pocket of the housing.

10. The sensor coupling of claim 1, further comprising a gripper flange configured to slide the gripper stop relative to the pipe and remove the housing from the pipe.

11. The sensor coupling of claim 10, wherein the gripper flange and the gripper stop are a single monolithic piece.

12. The sensor coupling of claim 1, wherein:
the sensor is a hydrophone coupled to the housing and disposed within a cavity defined within the first portion;
the second portion defines an angled section; and
the gripper stop is captured between the angled section of the second portion.

13. The sensor coupling of claim 12, wherein the second portion of the housing comprises angled sections that are angled in a direction opposite the tapered surface of the gripper stop, wherein as the angled sections move relative to the gripper stop, a compressive force exerted on the gripper stop increases.

14. The sensor coupling of claim 12, wherein the gripper stop further comprises a chamfer configured to support a seal within a pocket of the second portion of the housing.

15. The sensor coupling of claim 12, wherein the hydrophone is emersed in water and a gripper flange coupled to the gripper stop comprises a flange portion and an insertion portion.

16. A sensor coupling comprising:
a housing defining a first portion and a second portion defining an angled section;
a sensor coupled to the housing and disposed within a cavity defined within the first portion; and
a gripper stop comprising a tapered surface and captured between the angled section of the second portion and a pipe.

17. The sensor coupling of claim 16, wherein the sensor is a first hydrophone, and the gripper stop further comprises an insertion portion and a flange portion.

18. The sensor coupling of claim 16, further comprising a gripper flange coupled to the gripper stop, and wherein the gripper stop comprises a chamfer configured to support a seal within a pocket of the second portion of the housing.

19. A method for installing a sensor coupling, comprising:
sliding a housing comprising a gripper stop and a sensor over a pipe, the gripper stop comprising a tapered surface and teeth captured between the housing and the pipe; and
securing the housing to the pipe by exerting a force on the housing in a direction opposite from the pipe.

20. The method of claim 19, further comprising releasing the housing from the pipe by exerting a force on the gripper stop in a direction opposite from the pipe.
